(19) United States
(12) Patent Application Publication
(10) Pub. No.: US 2025/0053880 A1
(43) Pub. Date: Feb. 13, 2025

(54) INFORMATION PROCESSING DEVICE, NON-TRANSITORY COMPUTER-READABLE STORAGE MEDIUM, AND INFORMATION PROCESSING METHOD

(71) Applicant: Mitsubishi Electric Corporation, Tokyo (JP)

(72) Inventors: Jia QU, Tokyo (JP); Shotaro MIWA, Tokyo (JP)

(73) Assignee: Mitsubishi Electric Corporation, Tokyo (JP)

(21) Appl. No.: 18/930,478

(22) Filed: Oct. 29, 2024

Related U.S. Application Data
(63) Continuation of application No. PCT/JP2022/024125, filed on Jun. 16, 2022.

(51) Int. Cl. G06N 20/00

(52) U.S. Cl. CPC G06N 20/00

(57) ABSTRACT

An information processing device includes: an attention mechanism unit that calculates a context variable by weighting and adding a plurality of time-series variables by using an attention-mechanism learning model that is a learning model of an attention mechanism; a decision unit that estimates one decision included in a plurality of decisions based on confidence levels of the plurality of decisions calculated from the context variable and a latest variable included in the plurality of variables; a storage unit that stores result information correlating the context variable and the one decision; and an evaluating unit that evaluates a training state of at least the attention-mechanism learning model from the result information.

### CROSS REFERENCE TO RELATED APPLICATION

This application is a continuation application of International Application No. PCT/JP2022/024125 having an international filing date of Jun. 16, 2022.

### BACKGROUND OF THE INVENTION

### 1. Field of the Invention

The disclosure relates to an information processing device, a non-transitory computer-readable storage medium, and an information processing method.

### 2. Description of the Related Art

There is an attention mechanism as a technique to improve the estimation accuracy of a learning model. For example, NPL 1 describes that the use of an attention mechanism in the translation of a natural language with a neural network can improve translation accuracy.

Non-Patent Literature 1: Minh-Thang Luong et al., “Effective Approaches to Attention-based Neural Machine Translation,” arXiv preprint arXiv: 1508. 04025, 18 Aug. 2015.

### SUMMARY OF THE INVENTION

However, the internal processing of a learning model using deep reinforcement learning is a backbox and thus is not visible. For this reason, the user cannot readily determine whether the learning model has been effectively trained.

Accordingly, it is an object of one or more aspects of the disclosure to enable one to easily grasp the training state of a learning model using an attention mechanism.

An information processing device according to an aspect of the disclosure includes: storage; and processing circuitry to calculate a context variable by weighting and adding a plurality of time-series variables by using an attention-mechanism learning model, the attention-mechanism learning model being a learning model of an attention mechanism; to estimate one decision included in a plurality of decisions based on confidence levels of the plurality of decisions calculated from the context variable and a latest variable included in the plurality of variables; to cause the storage to store result information correlating the context variable and the one decision; and to evaluate a training state of at least the attention-mechanism learning model from the result information.

According to one or more aspects of the disclosure, one can easily grasp the training state of a learning model using an attention mechanism.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating a configuration of an information processing device according to a first embodiment;

FIGS. 2A and 2B are block diagrams illustrating hardware configuration examples;

FIG. 3 is a schematic diagram for explaining a process executed in the information processing device according to the first embodiment;

FIG. 4 is a block diagram schematically illustrating a configuration of an information processing device according to a second embodiment;

FIG. 5 is a schematic diagram for explaining processing executed in the information processing device according to the second embodiment;

FIG. 6 is a block diagram schematically illustrating a configuration of an information processing device according to a third embodiment;

FIG. 7 is a schematic diagram for explaining processing executed in the information processing device according to the third embodiment;

FIG. 8 is a block diagram schematically illustrating a configuration of an information processing device according to a fourth embodiment; and

FIG. 9 is a schematic diagram for explaining processing executed in the information processing device according to the fourth embodiment.

### DETAILED DESCRIPTION OF THE INVENTION

### First Embodiment

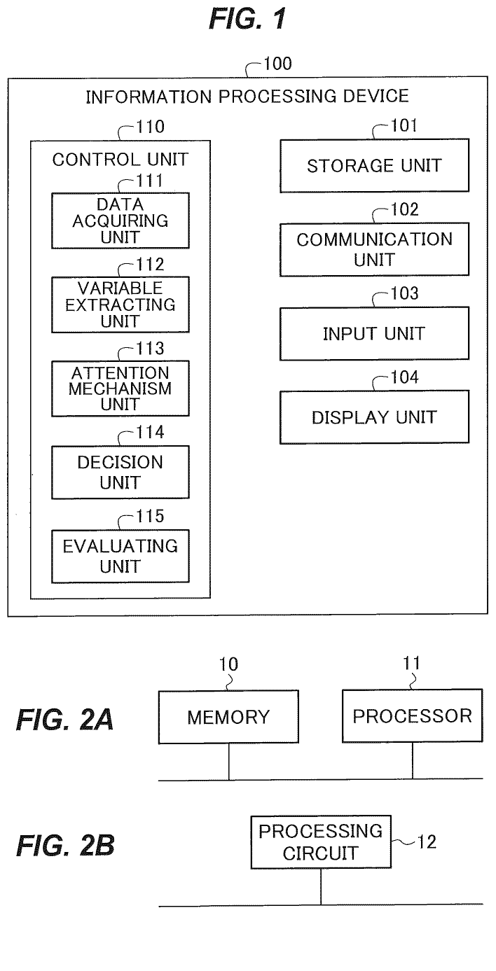

FIG. 1 is a block diagram schematically illustrating a configuration of an information processing device 100 according to the first embodiment.

The information processing device 100 includes a storage unit 101, a communication unit 102, an input unit 103, a display unit 104, and a control unit 110.

The storage unit 101 stores programs and data necessary for processing executed in the information processing device 100.

For example, the storage unit 101 stores at least an attention-mechanism learning model, which is a learning model used in an attention mechanism executed by the control unit 110. In the first embodiment, the storage unit 101 also stores an extractive learning model and a decision learning model, as will be described later.

The storage unit 101 further stores result information correlating decision results of the decisions made by the control unit 110 using estimation results of the attention mechanism, and the estimation results.

The communication unit 102 communicates with other devices. For example, the communication unit 102 communicates with other devices via a network such as the Internet.

The input unit 103 accepts input from a user of the information processing device 100.

The display unit 104 displays information to a user of the information processing device 100. For example, the display unit 104 displays various screen images.

The control unit 110 controls processing executed in the information processing device 100. For example, the control unit 110 calculates a context state variable by using the attention mechanism to weight and add state variables that are needed to make a decision, and estimates a certain decision from the context state variable. The control unit 110 then correlates the context state variable and the decision estimated from the context state variable, and stores these in the storage unit 101 as result information.

In the following, a state variable is also simply referred to as a variable, and a context state variable is also simply referred to as a context variable.

The control unit 110 uses the result information stored in the storage unit 101 to evaluate the training state of at least the learning model used in the attention mechanism. In the first embodiment, the control unit 110 evaluates the training states of an extractive learning model, an attention-mechanism learning model, and a decision learning model, as described later.

The control unit 110 includes a data acquiring unit 111, a variable extracting unit 112, an attention mechanism unit 113, a decision unit 114, and an evaluating unit 115.

The data acquiring unit 111 acquires input data. The data acquiring unit 111 may acquire input data, for example, via the communication unit 102. When input data is stored in the storage unit 101, the data acquiring unit 111 may acquire input data from the storage unit 101.

The variable extracting unit 112 extracts state variables that are variables that can be used for making decisions, from the input data acquired by the data acquiring unit 111.

Here, the variable extracting unit 112 extracts state variables by using an extractive learning model, which is a learning model for extracting state variables from input data.

The attention mechanism unit 113 calculates a context state variable by causing a known attention mechanism to determine a weighted sum of the state variables extracted by the variable extracting unit 112. For example, the attention mechanism unit 113 uses a learning model stored in the storage unit 101 to weight the state variables extracted by the variable extracting unit 112 and add the weighted variables to calculate a context state variable as an estimation result.

On the basis of confidence levels of multiple decisions calculated from the context state variable estimated by the attention mechanism unit 113 and one latest state variable included in multiple state variables, the decision unit 114 estimates one decision included in the multiple decisions from the one decision included in the multiple decisions. The decision unit 114 then correlates the one decision and the context state variable, and stores these in the storage unit 101 as result information.

Here, the decision unit 114 performs estimation by using a decision learning model, which is a learning model for estimating one decision from a context variable.

The evaluating unit 115 evaluates the training state of at least an attention-mechanism learning model, which is a learning model used by the attention mechanism unit 113, from the result information stored in the storage unit 101.

In the first embodiment, the evaluating unit 115 evaluates the training states of the extractive learning model, the attention-mechanism learning model, and the decision learning model. However, when state variables are not extracted from input data, the evaluating unit 115 evaluates the training states of the attention-mechanism learning model and the decision learning model.

For example, the evaluating unit 115 assigns each of the multiple decisions to a cluster to specify multiple clusters and evaluates the clusters on the basis of distance or similarity between the clusters. In this case, the shorter the distance or the higher the similarity, the lower the evaluation.

A portion or the entirety of the control unit 110 described above can be implemented by, for example, a memory 10 and a processor 11 such as a central processing unit (CPU) that executes programs stored in the memory 10, as illustrated in FIG. 2A. In other words, the information processing device 100 can be implemented by what is commonly known as a computer. Such programs may be provided over a network or may be recorded and provided on a recording medium. That is, such programs may be provided, for example, as a program product.

A portion or the entirety of the control unit 110 can also be implemented by, for example, a single circuit, a composite circuit, a processor operated by a program, a parallel processor operated by a program, a processing circuit 12 such as an application specific integrated circuit (ASIC) or a field programmable gate array (FPGA), as illustrated in FIG. 2B.

As described above, the control unit 110 can be implemented by processing circuitry.

The storage unit 101 can be implemented by storage, such as a hard disk drive (HDD), or a solid-state drive (SSD).

The communication unit 102 can be implemented by a communication interface such a network interface card (NIC).

The input unit 103 can be implemented by an input interface such as a keyboard or a mouse.

The display unit 104 can be implemented by a display.

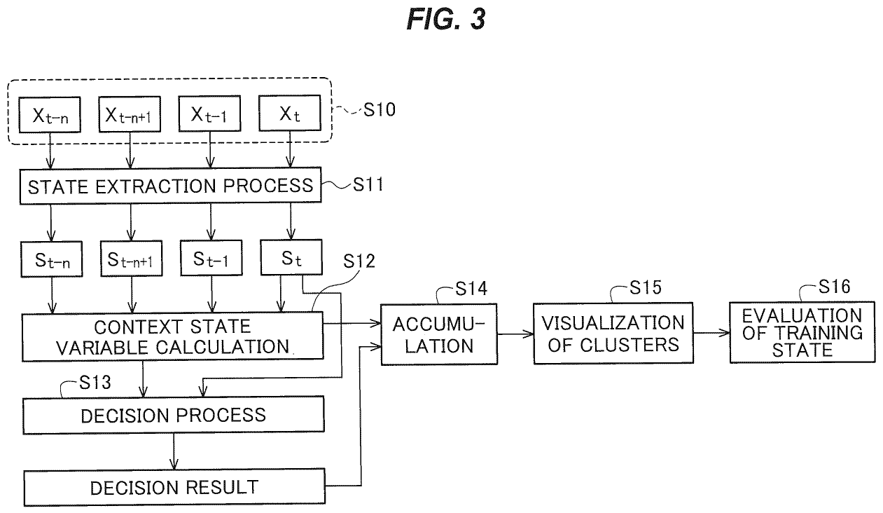

FIG. 3 is a schematic diagram for explaining processing executed in the information processing device 100 according to the first embodiment.

First, the data acquiring unit 111 acquires input data Xₜ₋ₙ, Xₜ₋ₙ₊₁, Xₜ₋₁, Xₜ (step S10). Here, the input data Xₜ₋ₙ, Xₜ₋ₙ₊₁, Xₜ₋₁, Xₜ is sensor values that are observation values, and is the data of the time-series t−n, t−n+1, t−1, t (where t and n are positive integers). For example, image data can be used as input data.

The data acquiring unit 111 gives the acquired input data Xₜ₋ₙ, Xₜ₋ₙ₊₁, Xₜ₋₁, Xₜ to the variable extracting unit 112.

The variable extracting unit 112 extracts, from the input data Xₜ₋ₙ, Xₜ₋ₙ₊₁, Xₜ₋₁, Xₜ, state variables Sₜ₋ₙ, Sₜ₋ₙ₊₁, Sₜ₋₁, and Sₜ, which are variables advantageous for the decision unit 114 to make decisions (step S11).

Here, the variable extracting unit 112 uses the extractive learning model, which is a neural network model stored in the storage unit 101, to extract the state variables Sₜ₋ₙ, Sₜ₋ₙ₊₁, Sₜ₋₁, and Sₜ from the input data Xₜ₋ₙ, Xₜ₋ₙ₊₁, Xₜ₋₁, Xₜ.

The variable extracting unit 112 gives the extracted state variables Sₜ₋ₙ, Sₜ₋ₙ₊₁, Sₜ₋₁, and Sₜ to the attention mechanism unit 113.

Here, the variable extracting unit 112 uses the extractive learning model; however, the first embodiment is not limited to such an example so long as the state variables Sₜ₋ₙ, Sₜ₋ₙ₊₁, Sₜ₋₁, and St are extracted using some function.

The attention mechanism unit 113 uses a learning model to estimate weighted values of the state variables Sₜ₋ₙ, Sₜ₋ₙ₊₁, Sₜ₋₁, and Sₜ and calculates the weighted sum to calculate a context state variable (step S12).

The attention mechanism unit 113 gives the calculated context state variable to the decision unit 114.

The decision unit 114 makes a decision from the context state variable and the latest state variable Sₜ (step S13).

Here, the decision unit 114 uses the decision learning model, which is a neural network model stored in the storage unit 101, to estimate a decision from the context state variable and the latest state variable.

The decision unit 114 then correlates the decision with the context state variable and stores these in the storage unit 101 as result information, thereby accumulating result information (step S14).

The evaluating unit 115 uses the result information stored in the storage unit 101 to evaluate the training state of at least the learning model used by the attention mechanism unit 113.

For example, in order to facilitate evaluation, the evaluating unit 115 converts the N-dimensional data obtained by assigning the result information of the respective decisions to clusters, into lower-dimensional data (step S15). Specifically, the evaluating unit 115 converts the N-dimensional data into two-dimensional data by using t-distributed stochastic neighbor embedding (t-SNE), to visualizes the clusters of the respective decision.

The evaluating unit 115 then calculates, for example, the distance or similarity between the clusters as evaluation values and thereby evaluates the training state (step S16).

For example, the evaluating unit 115 performs evaluation by comparing the evaluation values between clusters with a threshold. Specifically, when the distance between clusters is smaller than a predetermined threshold or when the similarity between clusters is higher than a predetermined threshold, the evaluating unit 115 determines that training is insufficient.

The determination result by the evaluating unit 115 may be displayed, for example, on the display unit 104.

As described above, according to the first embodiment, the training state of a learning model using the attention mechanism can be easily grasped.

### Second Embodiment

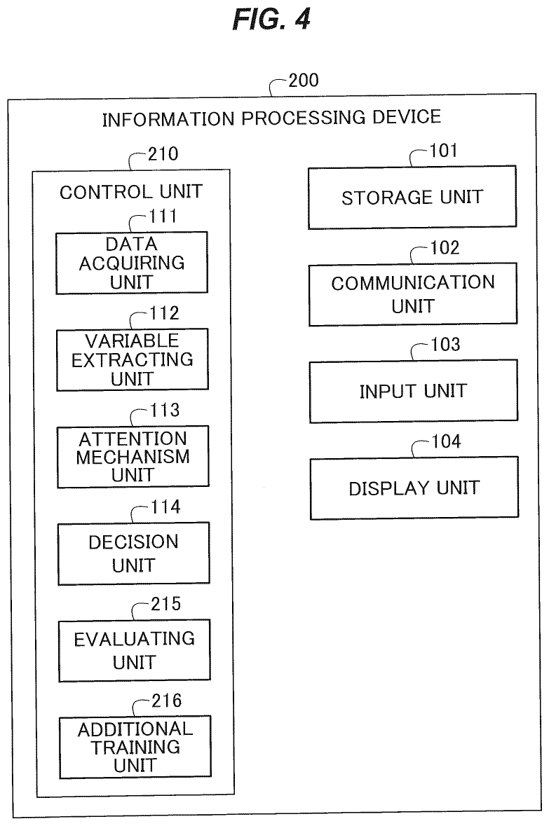

FIG. 4 is a block diagram schematically illustrating a configuration of an information processing device 200 according to the second embodiment.

The information processing device 200 includes a storage unit 101, a communication unit 102, an input unit 103, a display unit 104, and a control unit 210.

The storage unit 101, the communication unit 102, the input unit 103, and the display unit 104 of the information processing device 200 according to the second embodiment are respectively the same as the storage unit 101, the communication unit 102, the input unit 103, and the display unit 104 of the information processing device 100 according to the first embodiment.

The control unit 210 controls processing executed in the information processing device 200.

The control unit 210 according to the second embodiment executes the same processing as that executed by the control unit 110 according to the first embodiment, and also executes the following processing.

The control unit 210 trains a learning model by using additional training data depending on the evaluation result of a training state.

The control unit 210 includes a data acquiring unit 111, a variable extracting unit 112, an attention mechanism unit 113, a decision unit 114, an evaluating unit 215, and an additional training unit 216.

The data acquiring unit 111, the variable extracting unit 112, the attention mechanism unit 113, and the decision unit 114 of the control unit 210 according to the second embodiment are respectively the same as the data acquiring unit 111, the variable extracting unit 112, the attention mechanism unit 113, and the decision unit 114 of the control unit 110 according to the first embodiment.

The evaluating unit 215 uses the result information stored in the storage unit 101 to evaluate the training state of at least the learning model used by the attention mechanism unit 113.

The evaluating unit 215 then gives the evaluation result to the additional training unit 216. For example, the evaluating unit 215 compares the evaluation value and a threshold for each combination of two clusters to generate evaluation information indicating whether training is sufficient and gives the evaluation information to the additional training unit 216.

The additional training unit 216 refers to the evaluation information from the evaluating unit 215 and gives additional training data to the variable extracting unit 112 to perform additional training.

Here, when the evaluation by the evaluating unit 215 is lower than a predetermined threshold, the additional training unit 216 uses the additional training data to train at least an attention-mechanism learning model. In the second embodiment, the additional training unit 216 trains an extractive learning model, a decision learning model, and an attention-mechanism learning model.

For example, the additional training unit 216 performs training by using additional training data that is training data in which decisions whose evaluations are lower than a predetermined threshold among multiple decisions are established as being correct. In other words, the additional training unit 216 may give the variable extracting unit 112 training data classified into the two clusters decided to be insufficiently learned as additional training data. Here, the additional training data, for example, may be acquired from another device via the communication unit 102 or from the storage unit 101. A user may instruct from where the additional training data is to be acquired, for example, via the input unit 103.

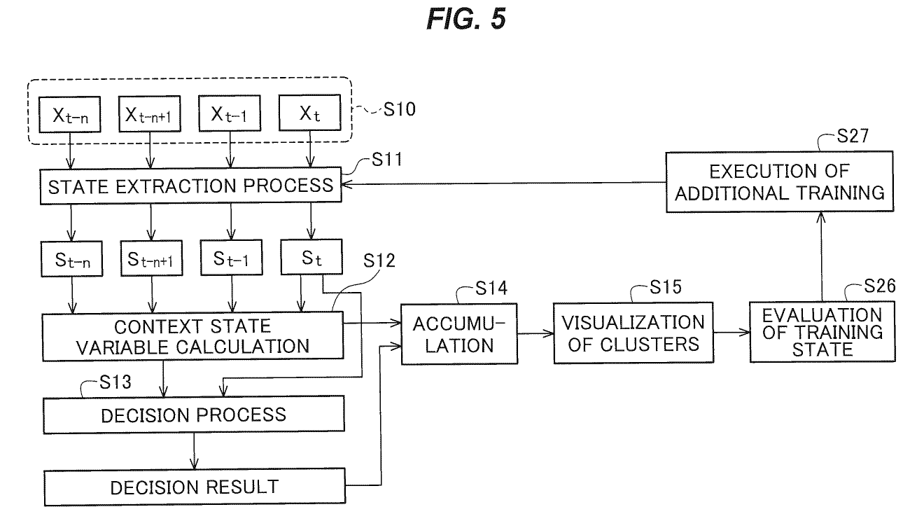

FIG. 5 is a schematic diagram for explaining processing executed in the information processing device 200 according to the second embodiment.

The processing of steps S10 to S15 in FIG. 5 is the same as the processing of steps S10 to S15 in FIG. 3.

In the second embodiment, the evaluating unit 215 calculates, for example, the distance or similarity between clusters as an evaluation value to evaluate the training state and thereby generates evaluation information indicating the evaluation result (step S26). The evaluation information is information indicating whether the respective combinations of two clusters are sufficiently learned. The generated evaluation information is given to the additional training unit 216.

The additional training unit 216 refers to the evaluation information and generates additional training data that is training data classified into clusters that are determined to be insufficient learned (step S27), and gives this additional training data to the variable extracting unit 112 to perform additional training.

As described above, a learning model using the attention mechanism according to the second embodiment can additionally learn clusters that are insufficiently learned.

Here, the evaluating unit 215 may use one threshold to determine whether the training is sufficient; however, the risk of decisions can be managed, for example, by using multiple thresholds. Specifically, for clusters of decisions that have no room for error, such as “stop” or “accelerate” a vehicle, the distance between the clusters has to be long or the similarity between clusters has to be low; therefore, the threshold can be adjusted to manage the risk of the decisions.

### Third Embodiment

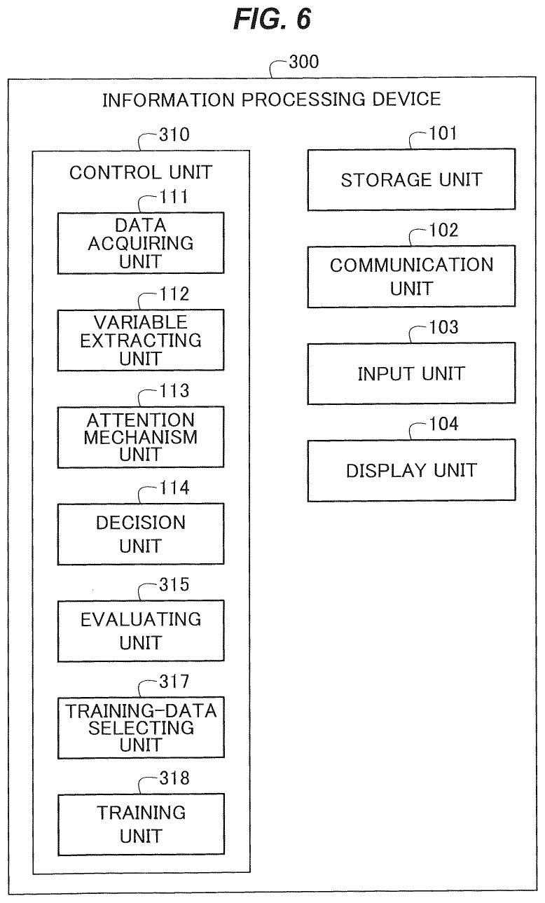

FIG. 6 is a block diagram schematically illustrating a configuration of an information processing device 300 according to the third embodiment.

The information processing device 300 includes a storage unit 101, a communication unit 102, an input unit 103, a display unit 104, and a control unit 310.

The storage unit 101, the communication unit 102, the input unit 103, and the display unit 104 of the information processing device 300 according to the third embodiment are respectively the same as the storage unit 101, the communication unit 102, the input unit 103, and the display unit 104 of the information processing device 100 according to the first embodiment.

The control unit 310 controls processing executed in the information processing device 300.

The control unit 310 according to the third embodiment executes the same processing as that executed by the control unit 110 according to the first embodiment, and also executes the following processing.

The control unit 310 selects training data in accordance with an evaluation result of a training state and uses the selected training data to train a learning model.

The control unit 310 includes a data acquiring unit 111, a variable extracting unit 112, an attention mechanism unit 113, a decision unit 114, an evaluating unit 315, a training-data selecting unit 317, and a training unit 318.

The data acquiring unit 111, the variable extracting unit 112, the attention mechanism unit 113, and the decision unit 114 of the control unit 310 according to the third embodiment are respectively the same as the data acquiring unit 111, the variable extracting unit 112, the attention mechanism unit 113, and the decision unit 114 of the control unit 110 according to the first embodiment.

As in the first embodiment, the evaluating unit 315 uses the result information stored in the storage unit 101 to evaluate the training state of at least the learning model used by the attention mechanism unit 113.

In the third embodiment, the evaluating unit 315 give the training-data selecting unit 317 evaluation value information indicating the evaluation value for each combination of two clusters.

The training-data selecting unit 317 refers to the evaluation value information from the evaluating unit 315 and selects the training data for training at least an attention-mechanism learning model.

Here, the training-data selecting unit 317 selects the training data so that the lower the evaluation corresponding to a decision, the greater the number of training data items for which the decision is correct. In other words, the training-data selecting unit 317 selects training data so that the lower the evaluation by an evaluation value indicated in the evaluation value information, i.e., the shorter the distance or the higher the similarity between clusters, the greater the number of training data items classified into those clusters. The training data may be stored in the storage unit 101 or in another device. When the training data is stored in another device, the training-data selecting unit 317 may access the device via the communication unit 102 and select the training data.

The training unit 318 uses the training data selected by the training-data selecting unit 317 to train at least the attention-mechanism learning model.

For example, the training unit 318 performs training by giving the training data selected by the training-data selecting unit 317 to the variable extracting unit 112.

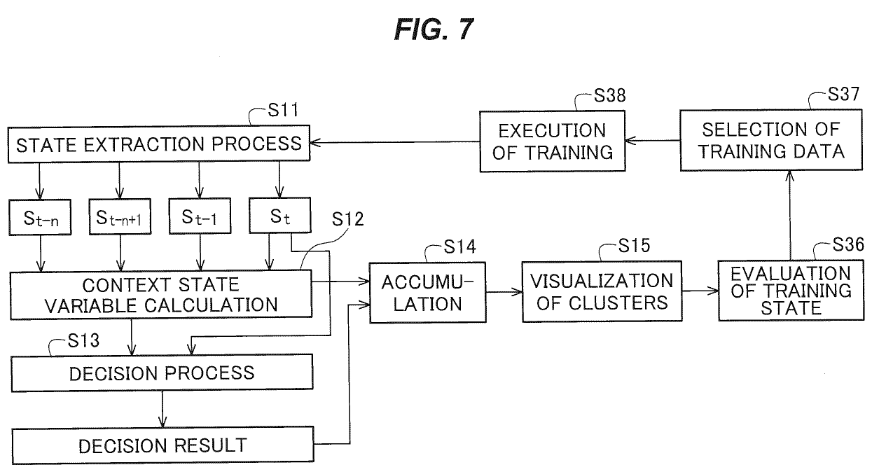

FIG. 7 is a schematic diagram for explaining processing executed in the information processing device 300 according to the third embodiment.

FIG. 7 illustrates processing executed to perform training using training data in the information processing device 300.

As a premise, the training-data selecting unit 317 gives the training unit 318 initial training data that is training data selected without reference to evaluation value information. The training unit 318 gives the initial training data to the variable extracting unit 112 to perform initial training, and then training data is selected in accordance with the evaluation result of the initial training.

The processing of steps S11 to S15 in FIG. 7 is the same as the processing of steps S11 to S15 in FIG. 3.

In the third embodiment, the evaluating unit 315 calculates, for example, the distance or similarity between clusters as evaluation values to evaluate the training state and thereby generates evaluation value information indicating the evaluation values for the respective combinations of two clusters (step S36). The generated evaluation value information is given to the training-data selecting unit 317.

The training-data selecting unit 317 refers to the evaluation value information and selects the training data so that the lower the evaluation by an evaluation value indicated by the evaluation value information, the greater the number of training data items classified into the clusters (step S37). The training-data selecting unit 317 then gives the selected training data to the training unit 318.

The training unit 318 performs training by giving the training data selected by the training-data selecting unit 317 to the variable extracting unit 112 (step S38).

As described above, according to the third embodiment, training of a learning model using an attentional mechanism can be performed efficiently by selecting the training data that should be learned intensively.

Although the training-data selecting unit 317 selects the training data so that the lower the evaluation by an evaluation value indicated by the evaluation value information, the greater the number of training data items classified into the clusters, the third embodiment is not limited to such an example. For example, clusters of decisions that have no room for error, such as “stop” and “accelerate” a vehicle, can be preliminarily set in the training-data selecting unit 317 as clusters that should be learned intensively, so that the training-data selecting unit 317 can select training data including many of such clusters. Specifically, the training-data selecting unit 317 can increase the number of training data items to be selected by adding or multiplying a weight value that cause the evaluation value to be low for clusters that should to be learned intensively. Such a setting may be established, for example, by a user via the input unit 103.

### Fourth Embodiment

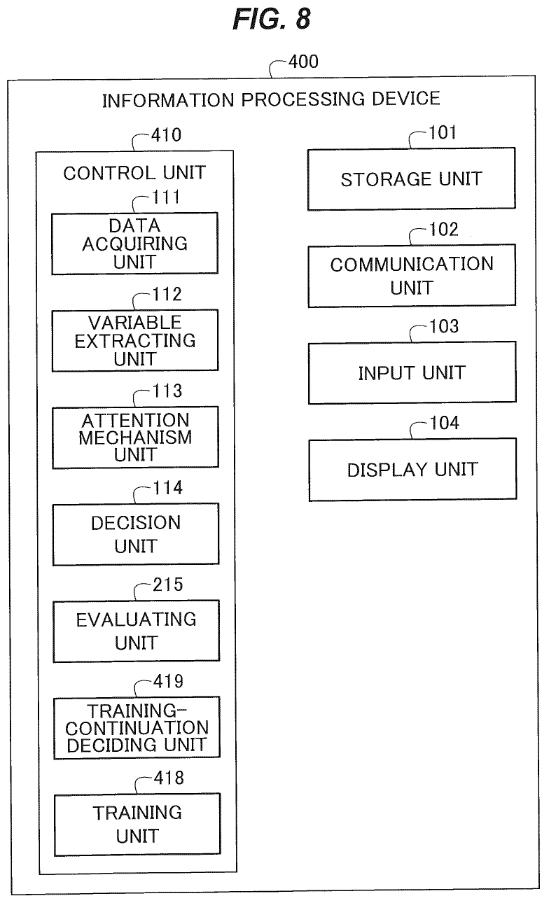

FIG. 8 is a block diagram schematically illustrating a configuration of an information processing device 400 according to the fourth embodiment.

The information processing device 400 includes a storage unit 101, a communication unit 102, an input unit 103, a display unit 104, and a control unit 410.

The storage unit 101, the communication unit 102, the input unit 103, and the display unit 104 of the information processing device 400 according to the fourth embodiment are respectively the same as the storage unit 101, the communication unit 102, the input unit 103, and the display unit 104 of the information processing device 100 according to the first embodiment.

The control unit 410 controls processing executed in the information processing device 400.

The control unit 410 according fourth embodiment executes the same processing as that executed by the control unit 110 according to the first embodiment, and also executes the following processing.

The control unit 410 decides whether to continue the training depending on the evaluation result of the training state; if it is decided to continue training, the training is continued, whereas if it is decided not to continue training, the training is ended.

The control unit 410 includes a data acquiring unit 111, a variable extracting unit 112, an attention mechanism unit 113, a decision unit 114, an evaluating unit 215, a training unit 418, and a training-continuation deciding unit 419.

The data acquiring unit 111, the variable extracting unit 112, the attention mechanism unit 113, and the decision unit 114 of the control unit 410 according to the fourth embodiment are respectively the same as the data acquiring unit 111, the variable extracting unit 112, the attention mechanism unit 113, and the decision unit 114 of the control unit 110 according to the first embodiment.

The evaluating unit 215 according to the fourth embodiment is the same as the evaluating unit 215 according to the second embodiment. However, in the fourth embodiment, the evaluating unit 215 gives evaluation information to the training-continuation deciding unit 419.

The training-continuation deciding unit 419 refers to the evaluation information from the evaluating unit 215 and decides whether the training of at least an attention-mechanism learning model is to be continued.

For example, when all or some evaluations by the evaluation values indicated by the evaluation information are lower than a predetermined threshold, in other words, if the distance is shorter than the predetermined threshold or if the similarity is higher than a predetermined threshold, the training-continuation deciding unit 419 decides that the training is to be continued.

The term “some evaluations” may refer to a predetermined number of evaluations or evaluations of predetermined clusters. For example, when all evaluations of important clusters that have no room for error are higher than a threshold, the training-continuation deciding unit 419 may decide that the training is not to be continued.

When the training-continuation deciding unit 419 decides that the training is to be continued, the training unit 418 performs training by giving the training data to the variable extracting unit 112. On the other hand, when the training-continuation deciding unit 419 decides that the training is not to be continued, the training unit 418 ends the training without giving the training data to the variable extracting unit 112.

The training data may be stored in the storage unit 101 or in another device. When the training data is stored in another device, the training unit 418 may access the device via the communication unit 102 and acquire the training data.

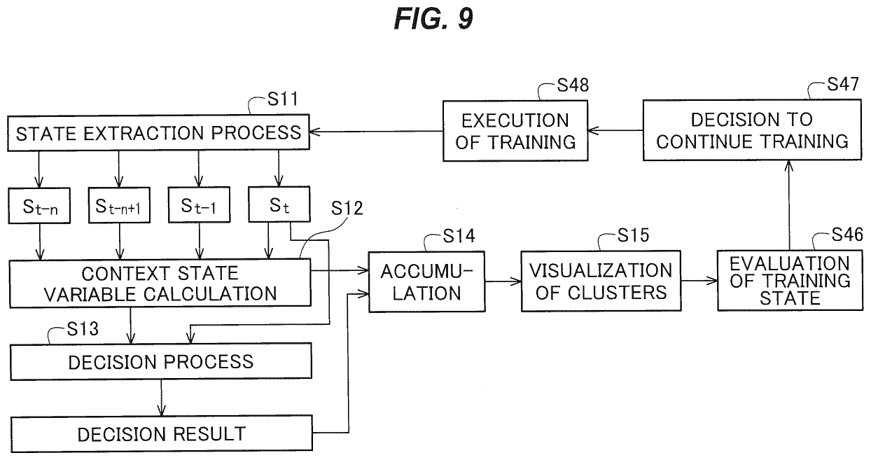

FIG. 9 is a schematic diagram for explaining processing executed in the information processing device 400 according to the fourth embodiment.

FIG. 9 illustrates processing executed to perform training using training data in the information processing device 400.

As a premise, the training unit 418 gives initial training data to the variable extracting unit 112 to perform initial training, and then decides whether to continue the training depending on the evaluation result of the initial training.

The processing of steps S11 to S15 in FIG. 9 is the same as the processing of steps S11 to S15 in FIG. 3.

In the fourth embodiment, the evaluating unit 215 calculates, for example, the distance or similarity between clusters as evaluation values to evaluate the training state and thereby generates evaluation information indicating the evaluation result (step S46). The evaluation information is information indicating whether the respective combinations of two clusters are sufficiently learned. The generated evaluation information is given to the training-continuation deciding unit 419.

The training-continuation deciding unit 419 refers to the evaluation information from the evaluating unit 215 and decides whether the training is to be continued (step S47).

When the training-continuation deciding unit 419 decides that the training is to be continued, the training unit 418 performs training by giving the training data to the variable extracting unit 112 (step S48).

As described above, according to the fourth embodiment, when training is sufficiently performed when a learning model using an attention mechanism is trained, the training can be ended. Thus, training can be performed efficiently.

Here, as in the second embodiment, the evaluating unit 215 may use one threshold to determine whether the training is sufficient; however, the risk of decisions can be managed, for example, by using multiple thresholds. Specifically, for clusters of decisions that have no room for error, such as “stop” or “accelerate” a vehicle, the distance between the clusters has to be long or the similarity between clusters has to be low; therefore, the threshold can be adjusted to manage the risk of the decisions.

What is claimed is:

1. An information processing device comprising:
storage; and
processing circuitry
to calculate a context variable by weighting and adding a plurality of time-series variables by using an attention-mechanism learning model, the attention-mechanism learning model being a learning model of an attention mechanism;
to estimate one decision included in a plurality of decisions based on confidence levels of the plurality of decisions calculated from the context variable and a latest variable included in the plurality of variables;
to cause the storage to store result information correlating the context variable and the one decision; and
to evaluate a training state of at least the attention-mechanism learning model from the result information.

2. The information processing device according to claim 1, wherein
the processing circuitry estimates the one decision by using a decision learning model and
evaluates the decision learning model and the attention-mechanism learning model, the decision learning model being a learning model estimating the one decision from the context variable.

3. The information processing device according to claim 2, wherein the processing circuitry extracts the variables from input data.

4. The information processing device according to claim 3, wherein
the processing circuitry extracts the variables by using an extractive learning model and
evaluates the extractive learning model, the decision learning model, and the attention-mechanism learning model, the extractive learning model being a learning model extracting the variables from the input data.

5. The information processing device according to claim 1, wherein the processing circuitry extracts the variables from input data.

6. The information processing device according to claim 5, wherein
the processing circuitry extracts the variables by using an extractive learning model and
evaluates the extractive learning model and the attention-mechanism learning model, the extractive learning model being a learning model extracting the variables from the input data.

7. The information processing device according to claim 1, wherein the processing circuitry assigns each of the decisions to a cluster to specify a plurality of clusters and evaluates the clusters based on distance or similarity between the clusters.

8. The information processing device according to claim 1, wherein the processing circuitry trains at least the attention-mechanism learning model by using additional training data when the evaluation is lower than a predetermined threshold.

9. The information processing device according to claim 8, wherein the processing circuitry uses, as the additional training data, training data in which decisions whose evaluations are lower than a predetermined threshold among the decisions are established as being correct.

10. The information processing device according to claim 1, wherein the processing circuitry
selects, in accordance with the evaluation, training data to be used to train at least the attention-mechanism learning model; and
trains at least the attention-mechanism learning model by using the selected training data.

11. The information processing device according to claim 10, wherein the processing circuitry performs selection in such a manner that the lower the evaluation corresponding to the one decision, the greater the number of training data items for which the one decision is correct.

12. The information processing device according to claim 1 wherein the processing circuitry
decides whether training of at least the attention-mechanism learning model is to be continued depending on the evaluation; and
continues the training by using training data used to train at least the attention-mechanism learning model when the training is decided to be continued, and ends the training when the training is not decided to be continued.

13. The information processing device according to claim 12, wherein the processing circuitry decides to continue the training when the evaluation of all of the decisions or some of the decisions is lower than a predetermined threshold.

14. A non-transitory computer-readable storage medium storing a program causing a computer to execute processing comprising:
calculating a context variable by weighting and adding a plurality of time-series variables by using an attention-mechanism learning model, the attention-mechanism learning model being a learning model of an attention mechanism;
estimating one decision included in a plurality of decisions based on confidence levels of the plurality of decisions calculated from the context variable and a latest variable included in the plurality of variables;
storing result information correlating the context variable and the one decision; and
evaluating a training state of at least the attention-mechanism learning model from the result information.

15. An information processing method comprising:
calculating a context variable by weighting and adding a plurality of time-series variables by using an attention-mechanism learning model, the attention-mechanism learning model being a learning model of an attention mechanism;
estimating one decision included in a plurality of decisions based on confidence levels of the plurality of decisions calculated from the context variable and a latest variable included in the plurality of variables;
storing result information correlating the context variable and the one decision; and
evaluating a training state of at least the attention-mechanism learning model from the result information.
